(19) United States
(12) Patent Application Publication
(10) Pub. No.: US 2026/0149281 A1
(43) Pub. Date: May 28, 2026

(54) A WIND TURBINE GENERATOR COMPRISING AN APPARATUS FOR ELECTRIC POWER CONVERSION

(71) Applicant: VESTAS WIND SYSTEMS A/S, Aarhus N (DK)

(72) Inventors: Catalin Gabriel DINCAN, Aalborg Øst (DK); Ciprian BIRIS, Hadsten (DK)

(21) Appl. No.: 19/121,522

(22) PCT Filed: Nov. 10, 2023
(86) PCT No.: PCT/DK2023/050274

§ 371 Date: Apr. 16, 2025

(30) Foreign Application Priority Data
Nov. 14, 2022 (DK) PA202270553

(51) Int. Cl. H02J 3/32; H02J 3/36; H02J 3/38; H02J 7/34; H02J 101/28

(52) U.S. Cl. CPC H02J 3/32; H02J 3/36; H02J 3/381; H02J 7/345; H02J 2101/28; H02J 2207/50

(57) ABSTRACT

A wind turbine generator (100a-e) comprising an electric generator (102) and an apparatus (104a-e) for electric power conversion, wherein the apparatus (104a-e) comprises: a first power converter (106) for converting AC power from the electric generator (102) to DC power; a second power converter (108) for converting DC power from the first power converter (106) to AC power to be provided to an electric power grid (110); a DC link (112) comprising a positive rail (114) and a negative rail (116) connecting the first power converter (106) to the second power converter (118); and an energy storage arrangement (118a-d) comprising multiple supercapacitors (120) connected or connectable to the DC link (112) so as to support the operation of one or more of the first and second power converters (106, 108). The energy storage arrangement (118a-d) comprises one or more DC-to-DC converters (122) for connecting one or more of the supercapacitors (122) of the energy storage arrangement (118a-d) to the DC link (112).

### TECHNICAL FIELD

Aspects of the present invention relate to a wind turbine generator, which comprises an electric generator and an apparatus for electric power conversion.

### BACKGROUND

In general, an electric power grid, for example referred to as a utility grid, may have defined parameters, for example a defined frequency, such as 50 Hz or 60 Hz. The stability of the electric power grid parameters is dependent on a variety of variables including the balance between generated electric power and consumed electric power in the electric power grid. In general, any imbalance between generated electric power and consumed electric power results in changes in the grid frequency of the electric power grid. When more electric power is generated than consumed in the electric power grid, the grid frequency increases. When more electric power is consumed than generated, the grid frequency decreases. In general, it is important to have a stable grid frequency in the electric power grid, i.e. to keep the frequency fluctuations of the grid frequency as small as possible.

In general, a grid code may be specified for an electric power grid, for example by the electric power grid operator, wherein the grid code defines parameters a power plant connected to the electric power grid has to meet, such as a power plant including one or more wind turbine generators, for example to provide sufficient frequency support to the electric power grid, or to provide sufficient voltage support to the electric power grid.

### SUMMARY

The inventors of the present invention have found drawbacks in conventional solutions for wind turbine generators, or power plants including one or more wind turbine generators, to provide support to the electric power grid. For example, some conventional solutions do not provide a sufficiently efficient support, such as frequency and/or voltage support, to the electric power grid.

An object of the invention is to provide a solution which mitigates or solves the drawbacks and problems of conventional solutions.

The above and further objects are solved by the subject matter of the independent claims. Further advantageous embodiments of the invention can be found in the dependent claims.

According to a first aspect of the invention, the above mentioned and other objects are achieved with a wind turbine generator, which comprises an electric generator and an apparatus for electric power conversion, wherein the apparatus comprises
a first power converter for converting AC power from the electric generator to DC power,
a second power converter for converting DC power from the first power converter to AC power to be provided to an electric power grid,
a DC link, which comprises a positive rail and a negative rail, connecting the first power converter to the second power converter, and
an energy storage arrangement comprising multiple supercapacitors connected or connectable to the DC link so as to support the operation of one or more of the first and second power converters,
wherein the energy storage arrangement comprises one or more DC-to-DC converters for connecting one or more of the supercapacitors of the energy storage arrangement to the DC link, and
wherein the DC-to-DC converter is connected in series with one or more of the supercapacitors of the energy storage arrangement.

An advantage of the wind turbine generator according to the first aspect is an improved support, such as an improved frequency and/or voltage support, provided by a wind turbine generator, or by a power plant including one or more wind turbine generators, to the electric power grid. An advantage of the wind turbine generator according to the first aspect is that the operation of one or more of the first and second power converters is improved. An advantage of the wind turbine generator according to the first aspect is that the electrical energy supply to the DC link during the operation of one or more of the first and second power converters is improved, whereby the operation or control of one or more of the first and second power converters is improved. An advantage of the wind turbine generator according to the first aspect is that one or more of the first and second power converters can be controlled according to the so-called grid forming control (GFC) mode in an improved manner, which will be disclosed in more detail in the detailed description in connection with the disclosure of embodiments hereinbelow.

For some embodiments, the first power converter may be referred to as a rectifier. For some embodiments, the second power converter may be referred to as an inverter. For some embodiments, the supercapacitor may be referred to as an ultracapacitor.

According to an advantageous embodiment of the wind turbine generator according to the first aspect, the energy storage arrangement is configured to provide electrical energy to the DC link so as to support the operation of one or more of the first and second power converters.

According to a further advantageous embodiment of the wind turbine generator according to the first aspect, the energy storage arrangement comprises one or more cabinets housing at least most of the supercapacitors of the energy storage arrangement. An advantage of this embodiment is that the arrangement of the supercapacitors is improved. An advantage of this embodiment is that the energy storage is optimized in view of cost and volume/size of access.

According to the first aspect, the DC-to-DC converter is connected in series with one or more of the supercapacitors of the energy storage arrangement. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to yet another advantageous embodiment of the wind turbine generator according to the first aspect, the multiple supercapacitors have a first terminal and a second terminal,
wherein the DC-to-DC converter has a first DC side and a second DC side,
wherein each one of the first and second DC sides comprises an input terminal and an output terminal,
wherein one of the positive and negative rails is connected or connectable to the first terminal via the input and output terminals of the first DC side of the DC-to-DC converter while the other one of the positive and negative rails is connected or connectable to the second terminal without any interconnected DC-to-DC converter, and
wherein the input and output terminals of the second DC side of the DC-to-DC converter are connected or connectable to one or more electric power sources different from the multiple supercapacitors.

An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to still another advantageous embodiment of the wind turbine generator according to the first aspect, the input terminal of the first DC side of the DC-to-DC converter is connected or connectable to one of the positive and negative rails, wherein the output terminal of the first DC side of the DC-to-DC converter is connected or connectable to the first terminal.

According to an advantageous embodiment of the wind turbine generator according to the first aspect, the electric power source comprises one or more of the group of:
an electric battery;
a local electric power source;
an auxiliary power source of a wind turbine generator;
the second power converter; and
the DC link.

An advantage of this embodiment is that the electrical energy supply to the DC link during the operation of one or more of the first and second power converters is further improved, whereby the operation or control of one or more of the first and second power converters is further improved.

According to a further advantageous embodiment of the wind turbine generator according to the first aspect, the energy storage arrangement comprises
one or more first circuits comprising one or more supercapacitors and one or more DC-to-DC converters for connecting the one or more the supercapacitors of the first circuit to the DC link, and
one or more second circuits comprising one or more supercapacitors connected or connectable to the DC link without any interconnected DC-to-DC converter.

An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved. An advantage of this embodiment is that the flexibility of the electrical energy supply to the DC link during the operation of one or more of the first and second power converters is improved.

According to another advantageous embodiment of the wind turbine generator according to the first aspect, the energy storage arrangement comprises multiple first circuits and multiple second circuits. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to yet another advantageous embodiment of the wind turbine generator according to the first aspect, the second circuit comprises two or more supercapacitors connected or connectable to the DC link without any interconnected DC-to-DC converter. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to still another advantageous embodiment of the wind turbine generator according to the first aspect, the wind turbine generator comprises a controller for controlling the electric power supply from the first and second circuits to the DC link. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to an advantageous embodiment of the wind turbine generator according to the first aspect, the controller is configured to control the electric power supply from the first and second circuits to the DC link based on the level of operation of one or more of the first and second power converters. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to a further advantageous embodiment of the wind turbine generator according to the first aspect, one of the first and second circuits is a default circuit which by default is initially connected for electric power supply to the DC link. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to an alternative advantageous embodiment of the wind turbine generator, the DC-to-DC converter is connected in parallel with one or more of the supercapacitors of the energy storage arrangement. An advantage of this embodiment is that the support, such as the frequency and/or voltage support, provided by the wind turbine generator, or by a power plant including the wind turbine generator, to the electric power grid is further improved. An advantage of this embodiment is that the electrical energy supply to the DC link during the operation of one or more of the first and second power converters is further improved, whereby the operation or control of one or more of the first and second power converters is further improved.

According to yet another advantageous embodiment of the wind turbine generator according to the first aspect, the multiple supercapacitors have a first terminal and a second terminal,
wherein the DC-to-DC converter has a first DC side and a second DC side,
wherein each one of the first and second DC sides comprises a first terminal and a second terminal,
wherein the first terminal of the first DC side of the DC-to-DC converter is connected or connectable to the first terminal of the multiple supercapacitors,
wherein the second terminal of the first DC side of the DC-to-DC converter is connected or connectable to the second terminal of the multiple supercapacitors, and
wherein the first terminal of the second DC side of the DC-to-DC converter is connected or connectable to one of the positive and negative rails while the second terminal of the second DC side of the DC-to-DC converter is connected or connectable to the other one of the positive and negative rails.

An advantage of this embodiment is that the support, such as the frequency and/or voltage support, provided by the wind turbine generator, or by a power plant including the wind turbine generator, to the electric power grid is further improved.

According to a second aspect of the invention, the above mentioned and other objects are achieved with a method for electric power conversion of AC power from an electric generator of a wind turbine generator to AC power to be provided to an electric power grid, wherein the method comprises:
controlling a first power converter to convert AC power from the electric generator to DC power;
controlling a second power converter to convert DC power from the first power converter to AC power, the second power converter being connected to the first power converter by a DC link; and
providing electrical energy to the DC link from an energy storage arrangement comprising multiple supercapacitors and one or more DC-to-DC converters connecting one or more of the supercapacitors of the energy storage arrangement to the DC link so as to support the operation of one or more of the first and second power converters.

Advantages of the method according to the second aspect correspond to advantages of the wind turbine generator according to the first aspect and its embodiments mentioned above or below.

According to an advantageous embodiment of the method according to the second aspect, the step of providing electrical energy to the DC link from the energy storage arrangement comprises providing electrical energy from one or more of the supercapacitors of the energy storage arrangement to the DC link via one or more DC-to-DC converters.

According to a further advantageous embodiment of the method according to the second aspect, the step of providing electrical energy to the DC link from the energy storage arrangement comprises providing electrical energy from an energy storage arrangement according to any one of the embodiments disclosed above or below.

According to a third aspect of the invention, the above mentioned and other objects are achieved with a computer program comprising instructions which, when the program is executed by a computer, cause the computer to carry out the method according to any one of the embodiments disclosed above or below. Advantages of the computer program according to the third aspect correspond to advantages of the wind turbine generator according to the first aspect and its embodiments mentioned above or below.

According to a fourth aspect of the invention, the above mentioned and other objects are achieved with a computer-readable medium comprising instructions which, when the instructions are executed by a computer, cause the computer to carry out the method according to any one of the embodiments disclosed above or below. Advantages of the computer-readable medium according to the fourth aspect correspond to advantages of the wind turbine generator according to the first aspect and its embodiments mentioned above or below.

According to an aspect of the present invention, the above-mentioned computer program and/or the computer-readable medium are/is configured to implement the method and its embodiments described herein.

According to a fifth aspect of the invention, the above mentioned and other objects are achieved with a control arrangement for controlling the electric power conversion of AC power from an electric generator of a wind turbine generator to AC power to be provided to an electric power grid, wherein the control arrangement is configured to:
control a first power converter to convert AC power from the electric generator to DC power;
control a second power converter to convert DC power from the first power converter to AC power, the second power converter being connected to the first power converter by a DC link; and
provide electrical energy to the DC link from an energy storage arrangement comprising multiple supercapacitors and one or more DC-to-DC converters connecting one or more of the supercapacitors of the energy storage arrangement to the DC link so as to support the operation of one or more of the first and second power converters.

Advantages of the control arrangement according to the fifth aspect correspond to advantages of the wind turbine generator according to the first aspect and its embodiments mentioned above or below.

It is to be appreciated that all the embodiments described for the method aspects of the invention are applicable also to the control arrangement aspects of the invention. Thus, all embodiments described for the method aspects of the invention may be performed by the control arrangement, which may include one or more controllers, control units, or control devices. The embodiments of the control arrangement have advantages corresponding to advantages mentioned above for the method and its embodiments.

According to an advantageous embodiment of the wind turbine generator according to the first aspect, the wind turbine generator comprises a control arrangement according to any one of the embodiments disclosed above or below.

According to a sixth aspect of the invention, the above mentioned and other objects are achieved with a power plant for providing electric power to an electric power grid, wherein the power plant comprises one or more wind turbine generators according to any one of the embodiments disclosed above or below.

The above-mentioned features and embodiments of the wind turbine generator, the method, the computer program, the computer-readable medium, the control arrangement and the power plant, respectively, may be combined in various possible ways providing further advantageous embodiments.

Further advantageous embodiments of the wind turbine generators, the method, the computer program, the computer-readable medium, the control arrangement and the power plant according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic diagram illustrating aspects of embodiments of the wind turbine generator according to the first aspect of the invention, to which embodiments of the method according to the second aspect of the invention may be applied;

FIG. 2 is a schematic diagram illustrating an embodiment of the power plant according to the sixth aspect of the invention;

FIG. 3 is a schematic circuit diagram illustrating an embodiment of the wind turbine generator according to the first aspect of the invention;

FIG. 4 is a schematic circuit diagram illustrating another embodiment of the wind turbine generator according to the first aspect of the invention;

FIG. 5 is a schematic circuit diagram illustrating aspects of embodiments of the wind turbine generator related to FIGS. 3 and 4;

FIG. 6 is a schematic circuit diagram illustrating another embodiment of the wind turbine generator according to the first aspect of the invention;

FIG. 7 is a schematic circuit diagram illustrating aspects of other embodiments of the wind turbine generator according to the first aspect of the invention;

FIGS. 8A-D are schematic circuit diagrams illustrating aspects of embodiments of the wind turbine generator related to FIG. 7;

FIG. 9 is a schematic circuit diagram illustrating aspects of embodiments of the wind turbine generator related to FIGS. 7 and 8;

FIG. 10 is a schematic flow chart illustrating aspects of embodiments of the method according to the second aspect of the invention; and

FIG. 11 is a schematic diagram illustrating an embodiment of the control arrangement according to the fifth aspect of the invention, in which a method according to any one of the herein described embodiments may be implemented.

### DETAILED DESCRIPTION

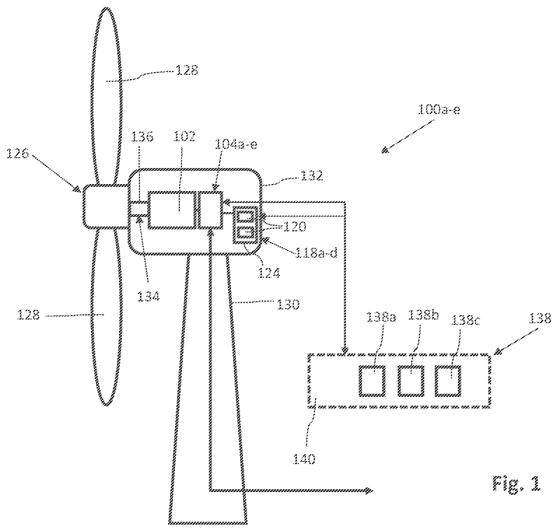

With reference to FIGS. 1 to 9, embodiments of the wind turbine generator 100a-e according to the first aspect of the invention are schematically illustrated. The wind turbine generator 100a includes an electric generator 102. The wind turbine generator 100a includes an apparatus 104a-e for electric power conversion.

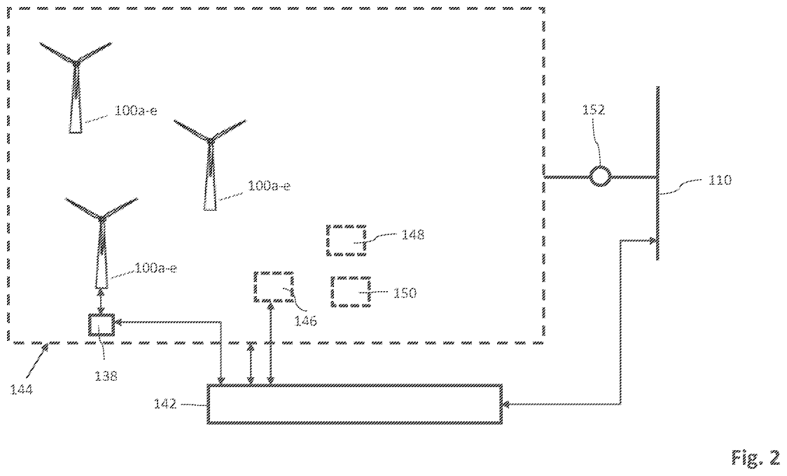

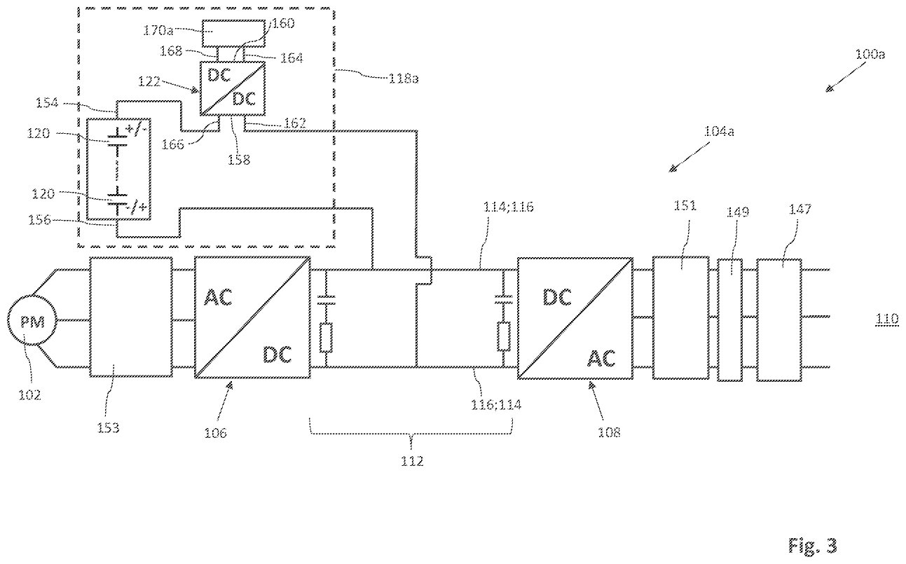

With reference to FIG. 3, the apparatus 104a includes a first power converter 106 for converting AC power from the electric generator 102 to DC power. The apparatus 104a includes a second power converter 108 for converting DC power from the first power converter 106 to AC power to be provided to an electric power grid 110 (see FIG. 2). The apparatus 104a includes a DC link 112. The DC link 112 includes a positive rail 114 and a negative rail 116. The DC link 112, and/or the positive and negative rails 114, 116, connects/connect, more specifically electrically connects/connect, the first power converter 106 to the second power converter 108. For some embodiments, the first power converter 106 may be referred to as a rectifier. For some embodiments, the second power converter 108 may be referred to as an inverter. For some embodiments, each power converter 106, 108 may be referred to as an electric power converter. For some embodiments, the DC link 112 may be described to connect a DC side of the first power converter 106 to a DC side of the second power converter 108.

With reference to FIG. 3, the apparatus 104a includes an energy storage arrangement 118a comprising multiple supercapacitors 120 connected or connectable, more specifically electrically connected/connectable, to the DC link 112 so as to support the operation of one or more of the first and second power converters 106, 108, i.e., to support the operation (or the function, or the functionality, or the performance, or the control) of the first power converter 106, or of the second power converter 108, or of both of the first and second power converters 106, 108. For some embodiments, the supercapacitor 120 may be referred to as an ultracapacitor. The energy storage arrangement 118a includes one or more DC-to-DC converters 122 for connecting, more specifically for electrically connecting, one or more of the supercapacitors 120 of the energy storage arrangement 118a to the DC link 112. More specifically, for some embodiments, the one or more DC-to-DC converters 122 connects/connect one or more of the capacitors 120 of the energy storage arrangement 118a to the DC link 112. For some embodiments, it may be defined that the energy storage arrangement 118a is configured to provide, or supply, electrical energy to the DC link 112 so as to support the operation of one or more of the first and second power converters 106, 108. For some embodiments, the energy storage arrangement 118a may be defined as an electrical energy storage arrangement. For some embodiments, the DC link 112 may be described as a DC circuit. It is to be understood that multiple supercapacitors 120 include two or more supercapacitors 120, for example, three, four, five, or more supercapacitors 120. For some embodiments, the energy storage arrangement may comprise one or more additional power sources, such as one or more electric batteries, and/or one or more hybrid batteries, for providing additional electrical energy to the DC link 112.

With reference to FIG. 1, for some embodiments, the wind turbine generator 100a-e may comprise a rotor 126 including one or more blades 128, or rotor blades 128, for example two or more blades 128, such as three blades 128, or more. The wind turbine generator 100a-e may comprise a tower 130 and a nacelle 132 mounted to the top of the tower 130. The rotor 126 may be connected, such as rotatably connected or mounted, to the nacelle 132. The rotor 126 may be connected to the electric generator 102. The rotor 126 is configured to drive the electric generator 102. The nacelle 132 may house the electric generator 102. The electric generator 102 may be a permanent magnet, PM, generator, or any other type of electric generator.

With reference to FIG. 1, the rotor 126 is rotatable by action of the wind. The wind-induced rotational energy of the blades 128 and rotor 126 may be transferred via a coupling 134, for exampling including one or more shafts 136, to the electric generator 102. Thus, the wind turbine generator 100a-e may be described to be configured to convert kinetic energy of the wind to mechanical energy, or rotational energy, by way of the blades 128 and, subsequently, to electric power by way of the electric generator 102. The apparatus 104a-e, such as the first and second power converters 106, 108, may be described to be connected, more specifically electrically connected, to the electric generator 102. The wind turbine generator 100a-e and/or the electric generator 102 may be connected to the electric power grid 110 via said apparatus 104a-e, more specifically via the first and second power converters 106, 108 of the apparatus 104a-e.

With reference to FIGS. 1 and 3, the nacelle 132 may house one or more of the first and second power converters 106, 108. For some embodiments, one or more of the first and second power converters 106, 108 may be located elsewhere, for example in the tower 130. For example, the first power converters 106 may be located in the nacelle 132 while the second power converter 108 may be located in the tower 130, such as in the lower part of the tower 130. However, other locations of the first and second power converters 106, 108 are possible. The nacelle 132 may house the energy storage arrangement 118a and/or the multiple supercapacitors 120, or the energy storage arrangement 118a and/or the multiple supercapacitors 120 may be located elsewhere, for example in the tower 130, or outside the tower 130 and nacelle 132.

With reference to FIG. 1, for some embodiments, the energy storage arrangement 118a may include one or more cabinets 124 housing at least most of the supercapacitors 120 of the energy storage arrangement 118a, for example, substantially all of the supercapacitors 120 of the energy storage arrangement 118a. The cabinet 124 may located inside or outside the nacelle 132. The cabinet 124 may located in the tower 130, for example in the top portion of the tower 130, for example adjacent to the nacelle 132, or in the bottom portion of the tower 130, or anywhere therebetween. The cabinet 124 may be located outside both the tower 130 and nacelle 132, and may, for example, be placed on ground, underground, or on, or in, a foundation of an offshore wind turbine generator. The cabinet 124 may be attached to the exterior of the tower 130 or of the nacelle, such as to the top, bottom or lateral side of the nacelle 132. Inside the nacelle 132, the cabinet 124 may have various different positions in the relation to the electric generator 102 and/or the first and second power converters 106.

With reference to FIG. 1, the wind turbine generator 100a-e may comprise a control arrangement 138, or a controller 140, for controlling the wind turbine generator 100a-e. The control arrangement 138 of the wind turbine generator 100a may comprise the controller 140, which may be referred to as a wind turbine generator controller. The control arrangement 138 of the wind turbine generator 100a-e may be configured to communicate with and/or be connected to, or be part of, a control arrangement 142 of a power plant 144 (see FIG. 2) comprising one or more wind turbine generators 100a-e.

With reference to FIG. 1, for some embodiments, the wind turbine generator 100a-e may be referred to as a variable-speed wind turbine generator. It is to be understood that the wind turbine generator 100a-e may include further unites, components and/or devices, such as sensors, required for a wind turbine generator 100a-e. For example, the wind turbine generator 100a-e may be located offshore or on land.

With reference to FIG. 2, for some embodiments, the wind turbine generator 100a may be included in, or be part of, a power plant 144. In FIG. 2, an embodiment of the power plant 144 for providing electric power, or electrical energy, to an electric power grid 110 according to the sixth aspect of the invention is schematically illustrated. The power plant 144 includes one or more wind turbine generators 100a-e, for example two, three or more wind turbine generators 100a-e. For some embodiments, the wind turbine generator 100a-e may be described as a power source of the power plant 144 or as a power generator of the power plant 144. For some embodiments, the power plant 144 may include one or more additional power sources or power generators, such as solar cell panels/photo-voltaic panels 146, fuel cells 148 and/or electric battery units 150. For some embodiments, the power plant 144 may be referred to as a hybrid power plant. The power plant 144 may be connected, or connectable, to the electric power grid 110 via a point of common coupling, PCC, 152. For some embodiments, the electric power grid 110 may be referred to as a utility grid, an electrical grid, or an electric power network. For example, the power plant 144 may be located offshore or on land. The power plant 144 may include a control arrangement 142 for controlling the power plant 144. The control arrangement 142 of the power plant 144 may comprise, or be referred to as, a power plant controller, PPC.

With reference to FIG. 3, for some embodiments, the wind turbine generator 100a may include one or more transformers 147 between the electric power grid 110 and the apparatus 104a, or the second power converter 108. For some embodiments, the wind turbine generator 100a may include one or more circuit breakers 149 between the transformer 147 and the apparatus 104a, or the second power converter 108. For some embodiments, the wind turbine generator 100a may include one or more first filters 151 between the circuit breaker 149 and the apparatus 104a, or the second power converter 108. For some embodiments, the wind turbine generator 100a may include one or more second filters 153 between the electric generator 102 and the apparatus 104a, or the first power converter 106. For other embodiments, one or more of the transformer 147, circuit breaker 149, first filter 151 and second filter 153 may be located elsewhere, or be differently connected, than what is illustrated in FIG. 3.

With reference to FIG. 3, for some embodiments of the wind turbine generator 100a, the DC-to-DC converter 122 of the energy storage arrangement 118a may be connected in series with one or more of the supercapacitors 120 of the energy storage arrangement 118a, more specifically electrically connected in series with one or more of the supercapacitors 120.

An advantage of embodiments of the wind turbine generator 100a-e according to the first aspect is that the electrical energy supply to the DC link 112 during the operation of one or more of the first and second power converters 106, 108 is improved, whereby the operation or control of one or more of the first and second power converters 106, 108 is improved. By way of the improved operation of one or more of the first and second power converters 106, 108, the support, such as the frequency and/or voltage support, provided by the wind turbine generator 100a-e to the electric power grid is improved.

An advantage of embodiments of the wind turbine generator 100a-e according to the first aspect is that one or more of the first and second power converters 106, 108 can be controlled according to the so-called grid forming control (GFC) mode in an improved manner, and that different functionalities of the grid forming control (GFC) mode can be supported in an improved manner, for example by way of the improved electrical energy supply to the DC link 112 attained by embodiments of the wind turbine generator 100a-e. In general, in the grid forming control (GFC) mode, one or more of the first and second power converters 106, 108 makes/make the wind turbine generator 100a behave more like a conventional large synchronous generator compared to the more traditional grid following (GFL) mode. Having the wind turbine generator 100a-e behave more like a conventional large synchronous generator is advantageous for several reasons. For example, in general, the increasing penetration of variable-speed wind turbine generators in the electric power grid results in a reduction of the portion of connected conventional power plants including conventional large synchronous generators, which leads to a reduction of inertia in the electric power grid, since a conventional large synchronous generator provides an inertia response for providing frequency support to the electric power grid, while, in general, a variable-speed wind turbine generator is connected to the electric power via one or more power converters, i.e. the variable-speed wind turbine generator is decoupled from the electric power grid by one or more power converters, whereby the wind turbine generator cannot provide a true inertia response for providing frequency support to the electric power grid. However, conventional control schemes may be applied to a variable-speed wind turbine generator, which make the variable-speed wind turbine generator provide a so-called virtual inertia response, or an inertia emulation response, for providing frequency support to the electric power grid, and thus make the variable-speed wind turbine generator behave more like a conventional large synchronous generator. During a frequency drop in the electric power grid, additional electric power may thus be released from the variable-speed wind turbine generator to the electric power grid by way of one or more of said conventional control schemes applied to the variable-speed wind turbine generator so as to provide frequency support to the electric power grid. Said additional electric power is obtained from the kinetic or rotational energy stored in the rotating mass, or rotor, of the wind turbine generator, which in general results in a slowing down of the rotor of the wind turbine generator.

In general, in a traditional back-to-back converter system, where both the machine side converter (MSC), which corresponds to the first power converter 106 mentioned above, and the line side converter (LSC), which corresponds to the second power converter 108 mentioned above, are pulse width modulated-(PWM)-based converters, the machine side converter (MSC) ensures that the electric generator receives the required electric power from the DC link. Conventionally, the energy capacity of the DC link is small, which requires that the line side converter (LSC) controls the DC link capacitor voltage level. In general, in the grid forming control (GFC) mode, having a back-to-back converter system with both the machine side converter (MSC) and the line side converter (LSC) being PWM-based converters, the control strategy is opposite to the traditional control strategy mentioned above. In general, in the grid forming control (GFC) mode, the line side converter (LSC) supplies active power required by the electric power grid according to a phase lag, by means of a so-called swing equation, similar to how a conventional large synchronous generator operates. In general, this means that, in the grid forming control (GFC) mode, the voltage of the DC link is to be controlled by the machine side converter (MSC), since the active voltage vector of the line side converter (LSC) is used for controlling the active power to be supplied to the electric power grid. Requirements regarding grid forming control (GFC) may be included in the grid code specified for an electric power grid, for example by the electric power grid operator.

An advantage of embodiments of the wind turbine generator 100a-e according to the first aspect is that the application of the DC-to-DC converter 122 makes the electric energy utilization of the multiple supercapacitors 120 more efficient. Without a DC-to-DC converter, an installation of an excessive amount of supercapacitors would be required to meet requirements but only a small portion, such as approx. 10%, of the installed energy of supercapacitors would be utilized, which implies a high cost per installed energy of supercapacitors 120, i.e. a poor energy utilization. The application of the DC-to-DC converter 122 provides a lower cost per installed energy of supercapacitors 120 and/or an improved, or enhanced, utilization of the installed energy of supercapacitors 120.

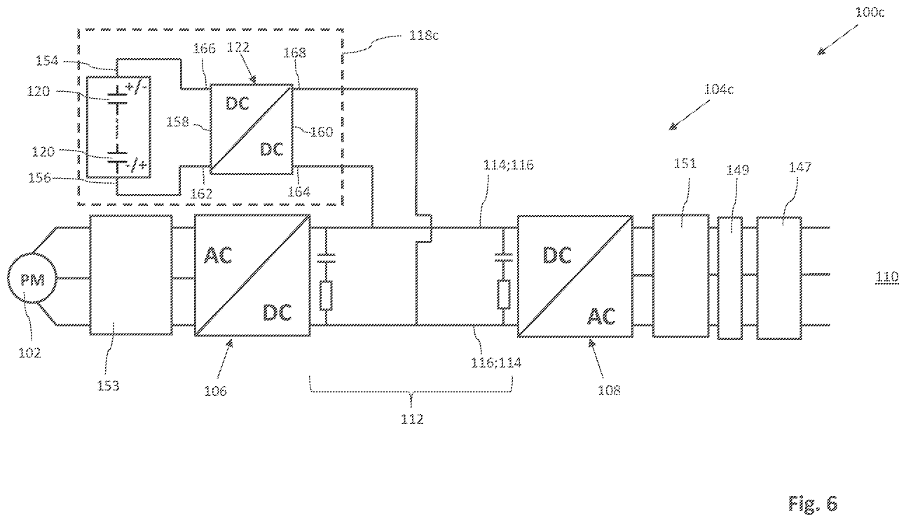

With reference to FIG. 3, by having the DC-to-DC converter 122 connected in series with one or more of the supercapacitors 120 of the energy storage arrangement 118a, the DC-to-DC converter 122 may only need to sustain nominal electric current but only approx. 5 to 35% of the voltage, which results in a lower power rating, even a lower power rating than a DC-to-DC converter 122 connected in parallel with one or more of the supercapacitors 120 of the energy storage arrangement 118c (see FIG. 6), whereby a lower cost per installed energy of supercapacitors 120 and/or an improved, or enhanced, utilization of the installed energy of supercapacitors 120 are/is attained. The series connected DC-to-DC converter 122 may be regarded as a trade-off, or compromise, between 1) only supercapacitors connected and 2) supercapacitors combined with a parallel DC-to-DC converter in terms of energy utilization, costs and volume/size of the energy storage. In general, the converter DC voltage range allows 10% utilization of installed energy of supercapacitors 120 without any DC-to-DC converter. By adding the series connected DC-to-DC converter, 5 to 25% extra use of energy can be added. In general, a further extension of the voltage range would literally mean that the DC-to-DC converter is designed for full voltage swing and nominal current, meaning the same rating as a parallel connected DC-to-DC converter. In general, supercapacitors should be discharged to 50 or 60% of their nominal voltage. Discharging to zero voltage is doable but would decrease the lifetime, or durability, of the supercapacitors.

With reference to FIG. 3, for some embodiments, it may be defined that the multiple supercapacitors 120 have a first terminal 154 and a second terminal 156. For some embodiments, it may be defined that the DC-to-DC converter 122 has a first DC side 158 and a second DC side 160. Each one 158, 160 of the first and second DC sides 158, 160 may include an input terminal 162, 164 and an output terminal 166, 168. For some embodiments, one 114, 116 of the positive and negative rails 114, 116 is connected or connectable, more specifically electrically connected/connectable, to the first terminal 154 via the input and output terminals 162, 166 of the first DC side 158 of the DC-to-DC converter 122 while the other one 114, 116 of the positive and negative rails 114, 116 is connected or connectable, more specifically electrically connected/connectable, to the second terminal 156 without any interconnected DC-to-DC converter. For some embodiments, said other one 114, 116 of the positive and negative rails 114, 116 may be directly connected or connectable to the second terminal 156. For some embodiments, the input and output terminals 164, 168 of the second DC side 160 of the DC-to-DC converter 122 may be connected or connectable, more specifically electrically connected/connectable, to one or more electric power sources 170a-b, 108, 112 different from the multiple supercapacitors 120. For some embodiments, it may be described that the input terminal 162 of the first DC side 158 of the DC-to-DC converter 122 is connected or connectable to one 114, 116 of the positive and negative rails 114, 116 while the output terminal 166 of the first DC side 158 of the DC-to-DC converter 122 is connected or connectable to the first terminal 154.

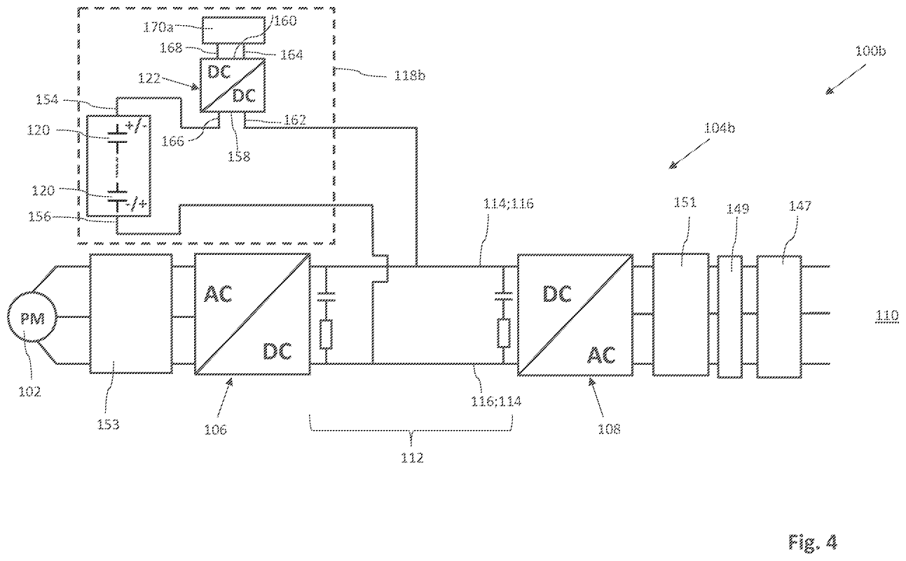

With reference to FIG. 4, another embodiment of the wind turbine generator 100b with an apparatus 104b and energy storage arrangement 118b modified in relation to the apparatus 104a of FIG. 3 is schematically illustrated. In the apparatus 104a of the embodiment of FIG. 3, the input terminal 162 of the first DC side 158 of the DC-to-DC converter 122 is connected or connectable to the bottom rail of the positive and negative rails 114, 116 while the top rail of the positive and negative rails 114, 116 is connected or connectable to the second terminal 156 of the multiple supercapacitors 120 without any interconnected DC-to-DC converter. In the apparatus 104b of the embodiment of FIG. 4, the input terminal 162 of the first DC side 158 of the DC-to-DC converter 122 is instead connected or connectable to the top rail of the positive and negative rails 114, 116 while the bottom rail of the positive and negative rails 114, 116 is connected or connectable to the second terminal 156 of the multiple supercapacitors 120 without any interconnected DC-to-DC converter. Otherwise, the embodiment of FIG. 4 may correspond to the embodiment of FIG. 3.

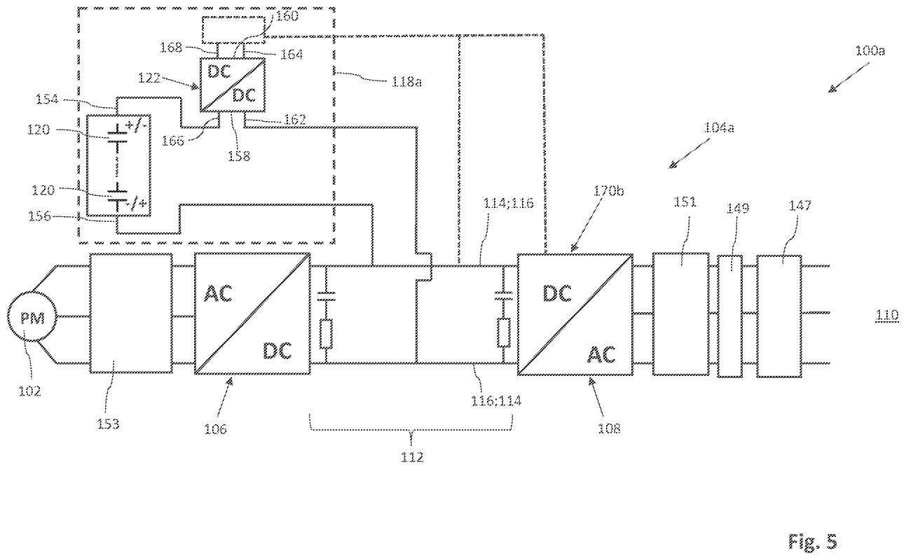

With reference to FIGS. 3 and 5, for some embodiments, the electric power source 170a-b, 108, 112 may include one or more of the group of:
an electric battery 170a;
a local electric power source 170a, 170b, 108, 112;
an auxiliary power source 170b of a wind turbine generator 100a;
the second power converter 108 of the apparatus 104a; and
the DC link 112 of the apparatus 104a.

With reference to FIG. 6, another embodiment of the wind turbine generator 100c with an apparatus 104c and energy storage arrangement 118c modified in relation to the apparatus 104a of FIG. 3 is schematically illustrated. In FIG. 6, the DC-to-DC converter 122 is connected in parallel with one or more of the supercapacitors 120 of the energy storage arrangement 118c, more specifically electrically connected in parallel with one or more of the supercapacitors 120. For some embodiments, it may be defined that each one 158, 160 of the first and second DC sides 158, 160 of the DC-to-DC converter 122 comprises a first terminal 166, 168 and a second terminal 162, 164. For some embodiments, the first terminal 166 of the first DC side 158 of the DC-to-DC converter 122 is connected or connectable to the first terminal 154 of the multiple supercapacitors 120 while the second terminal 162 of the first DC side 158 of the DC-to-DC converter 122 is connected or connectable to the second terminal 156 of the multiple supercapacitors 120. For some embodiments, the first terminal 168 of the second DC side 160 of the DC-to-DC converter 122 is connected or connectable to one 114, 116 of the positive and negative rails 114, 116 while the second terminal 164 of the second DC side 160 of the DC-to-DC converter 122 is connected or connectable to the other one 114, 116 of the positive and negative rails 114, 116. Otherwise, the embodiment of FIG. 6 may correspond to the embodiment of FIG. 3.

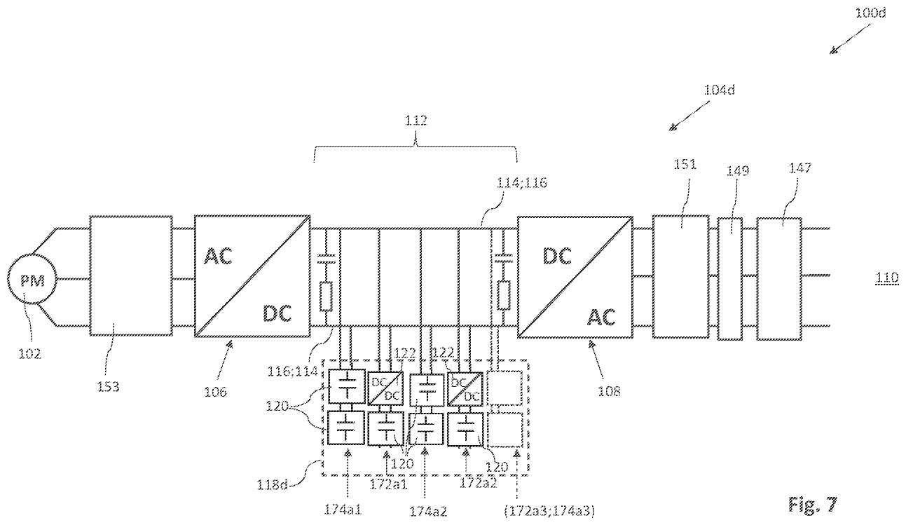

With reference to FIG. 7, another embodiment of the wind turbine generator 100d with an apparatus 104d and energy storage arrangement 118d modified in relation to the embodiment of FIG. 3 is schematically illustrated. The energy storage arrangement 118d of FIG. 7 includes one or more first circuits 172a1, 172a2. Each first circuit 172a1, 172a2 comprises one or more supercapacitors 120 and one or more DC-to-DC converters 122 for connecting the one or more the supercapacitors 120 of the first circuit 172a1, 172a2 to the DC link 112. The energy storage arrangement 118d of FIG. 7 includes one or more second circuits 174a1, 174a2. Each second circuit 174a1, 174a2 comprises one or more supercapacitors 120 connected or connectable to the DC link 112 without any interconnected DC-to-DC converter, i.e. without any DC-to-DC converter between the one or more supercapacitors 120 of the second circuit 174a1, 174a2 and the DC link 112. For some embodiments, the one or more supercapacitors 120 of the second circuit 174a1, 174a2 may be directly connected or connectable to the DC link 112. Otherwise, the embodiment of FIG. 7 may correspond to the embodiment of FIG. 3.

With reference to FIG. 7, an advantage of embodiments of the wind turbine generator 100d according to the first aspect is that the application of the one or more DC-to-DC converters 122 makes the electric energy utilization of the multiple supercapacitors 120 more efficient. Without the DC-to-DC converter, the energy utilization would be poor, limited by the DC link voltage range. However, with the DC-to-DC converter, the cost per MW would become large, because of the cost of the DC-to-DC converter, since DC-to-DC converters rated at nominal power are required according to requirements. An advantage of the embodiment of FIG. 7 is that an optimization is attained, for example in view of costs, volume/size of the energy storage and energy utilization of the supercapacitors 120. In general, a small volume or size of the energy storage is desired so as to minimize the bulkiness. For lower level functionalities and a low energy usage, one or more second circuits 174a1, 174a2 comprising one or more supercapacitors without any interconnected DC-to-DC converter may be applied while for higher level functionalities, such as charging or discharging of the supercapacitors 120 at a fast rate, one or more first circuits 172a1, 172a2 comprising one or more supercapacitors and one or more DC-to-DC converters 122 may be applied. Thus, an advantage of the embodiment of FIG. 7 is that the electrical energy supply to the DC link 112 during the operation of one or more of the first and second power converters 106, 108 is improved and made more efficient, whereby the operation or control of one or more of the first and second power converters 106, 108 is improved. By way of the embodiment of FIG. 7, a lower cost per installed energy of supercapacitors 120 and/or an improved, or enhanced, utilization of the installed energy of supercapacitors 120 are/is attained.

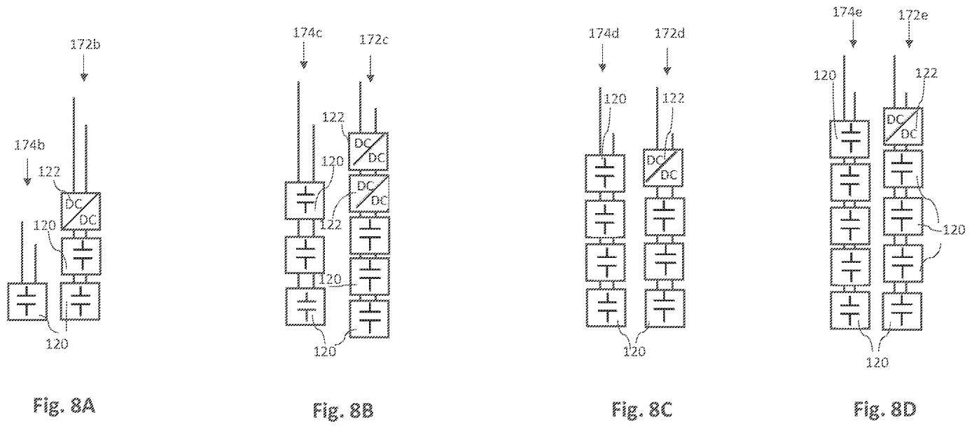

With reference to FIGS. 8A to 8D, several different embodiments of the first circuit 172b-e and of the second circuit 174b-e are schematically illustrated. One or more of the first and second circuits 172b-e, 174b-e illustrated in FIGS. 8A to 8D may replace, or supplement, one or more of the first circuits 172a1, 172a2 and second circuits 174a1, 174a2 illustrated in FIG. 7 so as to provide further embodiments of the wind turbine generator.

With reference to FIGS. 7 and 8A to 8D, the illustrated first and second circuits 172a-e, 174a-e may be combined in various possible ways and the number of the first and second circuits 172a-e, 174a-e may be varied so as to provide further embodiments of the wind turbine generator. It is to be understood that further first and second circuits 172a-e, 174a-e, different form the ones illustrated in FIGS. 7 and 8A to 8D, are possible, for example with more or less supercapacitors 120 and/or more or less DC-to-DC converters 122. For some embodiments, the energy storage arrangement 118d may include multiple first circuits 172a1, 172a2 and multiple second circuits 174a1, 174a2. For some embodiments, the second circuit 174a1, 174a2, 174c, 174d, 174e may include two or more supercapacitors 120 connected or connectable to the DC link 112 without any interconnected DC-to-DC converter.

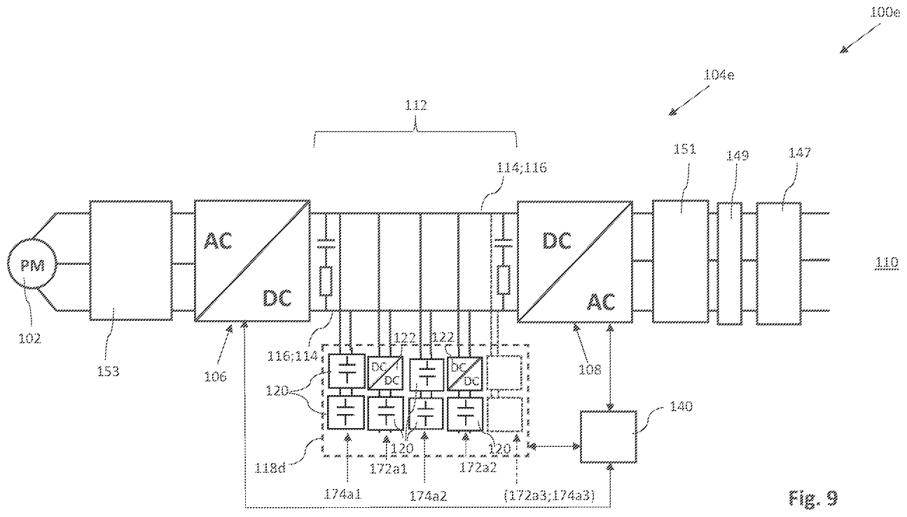

With reference to FIG. 9, another embodiment of the wind turbine generator 100e with an apparatus 104e modified in relation to the embodiment of FIG. 7 is schematically illustrated. The wind turbine generator 100e of FIG. 9 includes a controller 140 for controlling the electric power supply from the first and second circuits 172a-e, 174a-e to the DC link 112. For some embodiments, the controller 140 may be configured to control the electric power supply from the first and second circuits 172a-e, 174a-e to the DC link 112 based on the level of operation of one or more of the first and second power converters 106, 108. For some embodiments, one of the first and second circuits 172a-e, 174a-e may be a default circuit, which by default is initially connected for electric power supply to the DC link 112. Otherwise, the embodiment of FIG. 9 may correspond to the embodiment of FIG. 7.

With reference to FIGS. 3 to 9, one or more of the energy storage arrangement 118a-d, multiple supercapacitors 120 and DC-to-DC converter 122 may be connected, directly or indirectly, to the DC link 112, and/or to one another, by way of one or more busbars, electric cables, or electric lines, or any other electrical conductors, or by any combination thereof. For example, if the energy storage arrangement 118a-d is installed in the proximity of the DC link 112, for example in the nacelle 132 when the DC-link 112 is located in the nacelle 132, busbars may be used, or any other electrical conductors. For example, if the energy storage arrangement 118a-d is installed at a longer distance from the DC link 112, for example in the tower 130 when the DC-link 112 is located in the nacelle 132, electric cables may be used, or any other electrical conductors.

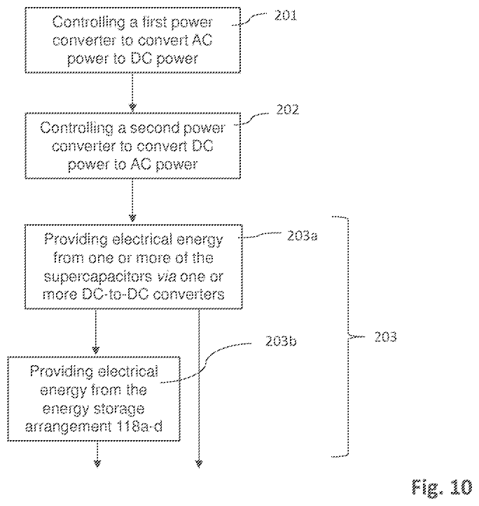

With reference to FIG. 10, aspects of embodiments of the method for electric power conversion of AC power from an electric generator 102 of a wind turbine generator 100a-e to AC power to be provided to an electric power grid 110 according to the second aspect of the invention are schematically illustrated. Embodiments of the method include the steps of:
controlling 201 a first power converter 106 to convert AC power from the electric generator 102 to DC power;
controlling 202 a second power converter 108 to convert DC power from the first power converter 106 to AC power, wherein the second power converter 108 is connected to the first power converter 106 by a DC link 112; and
providing 203 (or supplying) electrical energy to the DC link 112 from an energy storage arrangement 118a-d comprising multiple supercapacitors 120 and one or more DC-to-DC converters 122 connecting one or more of the supercapacitors 120 of the energy storage arrangement 118a-d to the DC link 112 so as to support the operation of one or more of the first and second power converters 106, 108.

For some embodiments, it may be defined that the method comprises:
converting AC power from the electric generator 102 to DC power by way of a first power converter 106; and
converting DC power from the first power converter 106 to AC power by way of a second power converter 108, the second power converter 108 being connected to the first power converter 106 by a DC link 112.

With reference to FIG. 10, for some embodiments, the step of providing 203 electrical energy to the DC link 112 from the energy storage arrangement 118a-d may include providing 203a electrical energy from one or more of the supercapacitors 120 of the energy storage arrangement 118a-d to the DC link 112 via one or more DC-to-DC converters 122.

With reference to FIG. 10, for some embodiments, the step of providing 203 electrical energy to the DC link 112 from the energy storage arrangement 118a-d may include providing 203b electrical energy from an energy storage arrangement 118 a-d according to any one of the embodiments disclosed above or below.

For example, embodiments of the method according to the second aspect of the invention may be applied to the wind turbine generator 100a-e illustrated above. However, embodiments of the method according to the second aspect may also be applied to other wind turbine generators.

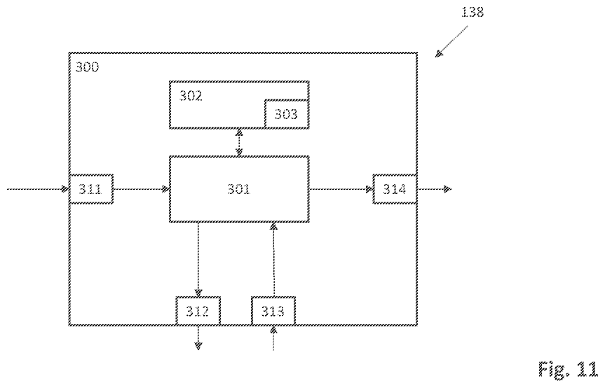

With reference to FIGS. 1 and 11, aspects of embodiments of the control arrangement 138 for controlling the electric power conversion of AC power from an electric generator 102 of a wind turbine generator 100a-e to AC power to be provided to an electric power grid 110 according to the fifth aspect of the invention are schematically illustrated. Embodiments of the control arrangement 138 are configured to:
control 201 a first power converter 106 to convert AC power from the electric generator 102 to DC power;
control 202 a second power converter 108 to convert DC power from the first power converter 106 to AC power, the second power converter 108 being connected to the first power converter 106 by a DC link 112; and
provide 203 electrical energy to the DC link 112 from an energy storage arrangement 118a-d comprising multiple supercapacitors 120 and one or more DC-to-DC converters 122 connecting one or more of the supercapacitors 120 of the energy storage arrangement 118a-d to the DC link 112 so as to support the operation of one or more of the first and second power converters 106, 108.

With reference to FIG. 1, the illustrated embodiment of the control arrangement 138 includes a first control unit 138a for controlling the first power converter 106 in order to perform step 201 in FIG. 10. The illustrated embodiment of the control arrangement 138 includes a second control unit 138b for controlling the second power converter 108 in order to perform step 202 in FIG. 10. The illustrated embodiment of the control arrangement 138 includes a third control unit 138c for providing electrical energy to the DC link 112 from an energy storage arrangement 118a-d in order to perform steps 203, 203a, and 203b in FIG. 10, and/or for controlling the electrical energy supply to the DC link 112 from the energy storage arrangement 118a-d.

With reference to FIG. 1, for some embodiments, the control arrangement 138 is configured to directly or indirectly communicate, for example via signal lines (or cables or wires) or wirelessly, with one or more of the group of: the wind turbine generator 100a-e; the power plant 144; the electric power grid 110; sensors; and other devices or systems of the wind turbine generator 100a-e or of power plant 144.

FIG. 11 shows in schematic representation an embodiment of the control arrangement 138 according to the fifth aspect of the invention, which may include a control unit 300, which may correspond to or may include one or more of the above-mentioned units 138a-c of the control arrangement 138. The control unit 300 may comprise a computing unit 301, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 301 is connected to a memory unit 302 arranged in the control unit 300. The memory unit 302 provides the computing unit 301 with, for example, the stored program code and/or the stored data which the computing unit 301 requires to be able to perform computations. The computing unit 301 is also arranged to store partial or final results of computations in the memory unit 302.

With reference to FIG. 11, in addition, the control unit 300 may be provided with devices 311, 312, 313, 314 for receiving and transmitting input and output signals. These input and output signals may contain waveforms, impulses, or other attributes which, by means of the devices 311, 313 for the reception of input signals, can be detected as information and can be converted into signals which can be processed by the computing unit 301. These signals are then made available to the computing unit 301. The devices 312, 314 for the transmission of output signals are arranged to convert signals received from the computing unit 301 in order to create output signals by, for example, modulating the signals, which, for example, can be transmitted to other parts and/or systems of, or associated with, the wind turbine generator 100a-e, or the power plant 144 (see FIGS. 1 and 2). Each of the connections to the devices for receiving and transmitting input and output signals can be constituted by one or more of a cable; a data bus; and a wireless connection.

Here and in this document, units are often described as being provided for performing steps of the method according to embodiments of the invention. This also includes that the units are designed to and/or configured to perform these method steps.

With reference to FIG. 1, the units 138a-c of the control arrangement 138 are in FIG. 1 illustrated as separate units. These units 138a-c may, however, be logically separated but physically implemented in the same unit, or can be both logically and physically arranged together. These units 138a-c may for example correspond to groups of instructions, which can be in the form of programming code, that are input into, and are utilized by a processor/computing unit 301 (see FIG. 11) when the units are active and/or are utilized for performing its method step.

With reference to FIGS. 1 and 11, the control arrangement 138, which may include one or more control units 300, for example one or more devices, controllers or control devices, according to embodiments of the present invention may be arranged to perform all of the method steps mentioned above, in the claims, and in connection with the herein described embodiments. The control arrangement 138 is associated with the above-described advantages for each respective embodiment of the method.

With reference to FIG. 11, according to the third aspect of the invention, a computer program 303 is provided, comprising instructions which, when the program is executed by a computer, cause the computer to carry out the method according to one or more of the embodiments disclosed above.

According to the third fourth of the invention, a computer-readable medium is provided, comprising instructions which, when the instructions are executed by a computer, cause the computer to carry out the method according to one or more of the embodiments disclosed above.

The person skilled in the art will appreciate that the herein described embodiments of the method according to the second aspect may be implemented in a computer program 303 (see FIG. 11), which, when it is executed in a computer, instructs the computer to execute the method. The computer program is usually constituted by a computer program product 303 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

The present invention is not limited to the above-described embodiments. Instead, the present invention relates to, and encompasses all different embodiments being included within the scope of the independent claims.

1. A wind turbine generator comprising an electric generator and an apparatus for electric power conversion, wherein the apparatus comprises
a first power converter for converting AC power from the electric generator to DC power,
a second power converter for converting DC power from the first power converter to AC power to be provided to an electric power grid,
a DC link comprising a positive rail and a negative rail connecting the first power converter to the second power converter, and
an energy storage arrangement comprising multiple supercapacitors connected or connectable to the DC link so as to support the operation of one or more of the first and second power converters,
wherein the energy storage arrangement comprises one or more DC-to-DC converters for connecting one or more of the supercapacitors of the energy storage arrangement to the DC link, and
wherein the DC-to-DC converter is connected in series with one or more of the supercapacitors of the energy storage arrangement.

2. A wind turbine generator according to claim 1, wherein the energy storage arrangement comprises one or more cabinets housing at least most of the supercapacitors of the energy storage arrangement.

3. A wind turbine generator according to claim 1, wherein the multiple supercapacitors have a first terminal and a second terminal,
wherein the DC-to-DC converter has a first DC side and a second DC side,
wherein each one of the first and second DC sides comprises an input terminal and an output terminal,
wherein one of the positive and negative rails is connected or connectable to the first terminal via the input and output terminals of the first DC side of the DC-to-DC converter while the other one of the positive and negative rails is connected or connectable to the second terminal without any interconnected DC-to-DC converter, and
wherein the input and output terminals of the second DC side of the DC-to-DC converter are connected or connectable to one or more electric power sources different from the multiple supercapacitors.

4. A wind turbine generator according to claim 3, wherein the input terminal of the first DC side of the DC-to-DC converter is connected or connectable to one of the positive and negative rails, and
wherein the output terminal of the first DC side of the DC-to-DC converter is connected or connectable to the first terminal.

5. A wind turbine generator according to claim 3, wherein the electric power source comprises one or more of the group of:
an electric battery;
a local electric power source;
an auxiliary power source of a wind turbine generator;
the second power converter; and
the DC link.

6. A wind turbine generator according to claim 1, wherein the energy storage arrangement comprises
one or more first circuits comprising one or more supercapacitors and one or more DC-to-DC converters for connecting the one or more the supercapacitors of the first circuit to the DC link, and
one or more second circuits comprising one or more supercapacitors connected or connectable to the DC link without any interconnected DC-to-DC converter.

7. A wind turbine generator according to claim 6, wherein the energy storage arrangement comprises multiple first circuits and multiple second circuits.

8. A wind turbine generator according to claim 6, wherein the wind turbine generator comprises a controller for controlling the electric power supply from the first and second circuits to the DC link, and
wherein the controller is configured to control the electric power supply from the first and second circuits to the DC link based on the level of operation of one or more of the first and second power converters.

9. A method for electric power conversion of AC power from an electric generator of a wind turbine generator to AC power to be provided to an electric power grid, wherein the method comprises:
controlling a first power converter to convert AC power from the electric generator to DC power;
controlling a second power converter to convert DC power from the first power converter to AC power, the second power converter being connected to the first power converter by a DC link; and
providing electrical energy to the DC link from an energy storage arrangement comprising multiple supercapacitors and one or more DC-to-DC converters connecting one or more of the supercapacitors of the energy storage arrangement to the DC link so as to support the operation of one or more of the first and second power converters.

10. A method according to claim 11, wherein the step of providing electrical energy to the DC link from the energy storage arrangement comprises providing electrical energy from an energy storage arrangement according to claim 1.

11. (canceled)

12. A control arrangement for controlling the electric power conversion of AC power from an electric generator of a wind turbine generator to AC power to be provided to an electric power grid, wherein the control arrangement is configured to:
control a first power converter to convert AC power from the electric generator to DC power;
control a second power converter to convert DC power from the first power converter to AC power, the second power converter being connected to the first power converter by a DC link; and
provide electrical energy to the DC link from an energy storage arrangement comprising multiple supercapacitors and one or more DC-to-DC converters connecting in series one or more of the supercapacitors of the energy storage arrangement to the DC link so as to support the operation of one or more of the first and second power converters.

13. (canceled)

12. A wind turbine, comprising:
a tower;
a nacelle disposed on the tower;
a generator disposed within the nacelle; and
a control arrangement for controlling the electric power conversion of AC power from the generator to AC power to be provided to an electric power grid wherein the control arrangement is configured to:
control a first power converter to convert AC power from the electric generator to DC power;
control a second power converter to convert DC power from the first power converter to AC power, the second power converter being connected to the first power converter by a DC link; and
provide electrical energy to the DC link from an energy storage arrangement comprising multiple supercapacitors and one or more DC-to-DC converters connecting in series one or more of the supercapacitors of the energy storage arrangement to the DC link so as to support the operation of one or more of the first and second power converters.
